(19) United States
(12) Patent Application Publication
(10) Pub. No.: US 2013/0050400 A1
(43) Pub. Date: Feb. 28, 2013

(54) Arrangement and Method to Prevent a Collision of a Flying Animal with a Wind Turbine

(71) Applicants: Henrik Stiesdal, Odense C. (DK); Jason Stege, Brande (DK); Soeren Oemann Lind, Naestved (DK); Farshid Arman, Lafayette, CA (US)

(72) Inventors: Henrik Stiesdal, Odense C. (DK); Jason Stege, Brande (DK); Soeren Oemann Lind, Naestved (DK); Farshid Arman, Lafayette, CA (US)

(21) Appl. No.: 13/222,540

(22) Filed: Aug. 31, 2011

(51) Int. Cl. H04N 5/225

(52) U.S. Cl. 348/36; 348/E05.024

(57) ABSTRACT

An arrangement and method to prevent a collision of a flying animal with a wind turbine is provided. A camera-system is arranged at the wind turbine and the camera-system generate images of the environment of the wind turbine. An evaluation system is coupled with the camera-system and the evaluation system evaluates the images to detect a flying animal within the environment of the wind turbine. A warning system is coupled with the evaluation system and the warning system generates a warning signal if the flying animal is detected by the evaluation system. The camera-system is configured to generate at least panoramic images of the wind turbine environment for the evaluation.

### FIELD OF INVENTION

The invention relates to an arrangement and a method to prevent a collision of a flying animal with a wind turbine.

### BACKGROUND OF INVENTION

Observations in the vicinity of wind turbines show, that birds and bats may be killed or injured by a direct collision of the animal with a wind turbine blade. In addition bats may be killed in the proximity of a wind turbine blade when the rotor of the wind turbine is in operation.

In the case of birds, mostly bigger birds, like birds of prey, are hit by wind turbine blades. Smaller birds, like singing birds, are not so often affected.

In the case of bats also the close encounter of a bat and a wind turbine blade can cause the death of a bat. This is due to the high pressure differences in the area surrounding a wind turbine blade that moves through the air. This pressure difference can damage the lungs of a bat.

In many of countries there are species of birds and bats that are endangered and protected. Many of them are recorded on a so called red list. Protecting these animals is very important and in some countries a legal requirement.

Thus the wind turbines, which are installed in areas where those animals occur, are stopped or set to a specific mode during the flying time of the birds or bats for their protection. This can be done during a certain time of the day, during breeding time or according to the seasonal migration of the animals.

This downtime of the turbine leads to a loss in energy production. Furthermore, in many instances the installation of wind turbines is forbidden altogether due to concerns for the animals.

Various solutions have been developed to avoid that flying animals come to the vicinity of a wind turbine or to stop or influence the wind turbine when an object is flying towards the wind turbine.

The flying objects are detected by radar or by optical detection means. Reference is made to these documents: JP2006125266-A2, JP2010185444-A2, JP2010193768-A2, EP2017470-A1, JP2009228554-A2, CN101416618-A, US2005162978-AA, WO10076500-A1, JP2009229237-A2, US2008260531-AA, DE202010010765-U1, JP2002039051-A2, DE202010003983-U1, U.S. Pat. No. 7,315,799-BA, JP2009203873-A2, WO09102001-A1, DE10231299-A1, US2010303623-AA, US2008298962-AA, WO10023253-A1, JP2009257322-A2, DE102007025314-A1, DE102009032578-A1, WO10058010-A2, DE102009016819-A1, U.S. Pat. No. 6,623,243-BA, JP2009191807-A2, US2010098844-AA, JP2010270623-A2, JP2010071100-A2, JP2010106667-A2, DE102007004027-A1, JP2010209863-A2, WO09130853-A1, U.S. Pat. No. 5,774,088-A.

In some solutions flying objects are scared away by noise, for example ultrasonic waves.

The disadvantage is that this solution does not work very well on avoiding the fatal encounters of bats with wind turbine blades.

In addition the bats are disturbed in their natural behavior. Also the high level of noise can disturb other animals and human beings in the vicinity of the wind turbine.

EP2017470-A1 describes a wind turbine capable of reducing the amount of collisions of flying objects with a blade or of bird strikes.

The wind turbine comprises an obstacle search device, capable of detecting a flying object existing in front of the wind turbine, e.g. in front of the rotor. The wind turbine further comprises a blade angle controller to control the angle of the blade including a rotation stop position.

The obstacle search device searches for the flying object continuously. If an approaching flying object is detected in the continuous searching, the blade angle controller changes the angle of the blades to a rotation-stop-position.

This shows the disadvantage that the wind turbine is always stopped when an object is flying in the vicinity of the wind turbine. That results in a loss in the energy production.

DE 10 2008 018 880 describes a monitoring method for wind turbines, to detect birds or flocks of birds in the area of the wind turbine. The birds are detected stereoscopically by at least one stereo camera which is arranged in the area of the wind turbine. Parameters like altitude, direction of flight, speed of flight are determined. On the basis of these parameters an assessment is carried out and a warning message is emitted.

This system is located in a certain distance of the wind turbine pointing in a certain direction to secure the area. To secure a wind turbine with this system multiple stereo camera systems are needed that point away from the wind turbine so the area around the wind turbine is secured. So just the birds approaching the wind turbine can be detected, but there is no detection of birds that have already entered the area of the wind turbine.

### SUMMARY OF INVENTION

An arrangement and a method to prevent a collision of a flying animal, like a bird or a bat, with a wind turbine are provided.

Accordingly, a collision of a flying animal with a wind turbine is prevented, whereby a camera-system is arranged at the wind turbine and the camera-system is configured to generate images of the environment of the wind turbine. An evaluation system is coupled with the camera-system and the evaluation system is configured to evaluate the images to detect a flying animal within the environment of the wind turbine.

A warning system is coupled with the evaluation system and the warning system is configured to generate a warning signal if the flying animal is detected by the evaluation system. The camera-system is configured to generate at least panoramic images of the wind turbine environment for the evaluation.

The term a flying animal is an animal of the “subphylum vertebrata” (according to Cuvier, 1812—i.e. bats and birds).

In one embodiment the camera-system comprises a camera working in the frequency range of the visible light. Thus the camera is configured to provide images in daylight situations or, with a flashlight attached, during nighttime.

In another embodiment the camera is configured to provide images in the spectrum of the infrared light. Thus the camera detects a flying animal of the subphylum vertebrata also during the nighttime or during the polar night. Thus the camera-system is also configured to provide images of bats that fly between dusk and dawn.

In another embodiment a combined camera-systems is used, that comprises a camera working in the frequency range of the visible light and a camera working in the frequency range of the infrared light. During nighttime the images are provided by the infrared camera. When a flying animal is detected, then a flashing light is activated, so that images with the camera working in the frequency range of the visible light are provided. Thus the species of the animal can be recognized on the images provided, also when the animal is detected during darkness by the infrared camera.

A panoramic camera is a camera that is configured to provide images that cover a wide angle in one direction of the image provided. This wide angle can cover up to 360°. The wide angle is used to check the environment in a mainly horizontal orientation or direction.

A panoramic camera is configured to provide a wide image up to a complete image of the area, mainly horizontal around the camera.

A wide angle image provided by the panoramic camera is referred to as a panoramic image.

As a flying animal approaches the wind turbine in a mainly horizontal way the panoramic camera observes the surrounding area horizontally. Thus the panoramic camera covers the main flight path of the flying animal approaching the wind turbine.

The evaluation system is an arrangement being capable to evaluate the images and to detect the flying animal based on the evaluation.

For example the pictures of the camera system are analyzed in a picture recognition system. When a flying animal is detected the evaluation system sends a signal to the warning system.

The warning system then generates a warning signal.

In one embodiment a warning signal is a signal to warn or scare off the flying animal. Thus the flying animal changes the direction of the flight and the wind turbine continues in producing energy.

In another embodiment the warning signal is a signal to influence the control of the wind turbine. Thus the rotor speed of the wind turbine is changed for example, to avoid a collision of the flying animal with the wind turbine rotor. As no scare-off-noise is used, the flying animal is not disturbed in its natural behavior.

In another embodiment the warning signal is a signal that is transmitted. The signal is transmitted to another wind turbine or to an operator in a remote place. Thus a second wind turbine in a wind park gets a warning signal about a flying animal approaching the turbine. This warning signal reaches the wind turbine before the flying animal is detected at the second turbine.

In one embodiment the evaluation system and the warning system are combined in one unit.

In another embodiment the evaluation system and the warning system are arranged in different units.

In another embodiment the evaluation system and/or the warning system are a part of another system being available in the wind turbine, like the control system of the turbine for example.

In one embodiment the camera-system comprises a first camera, which is configured to generate the panoramic images of the wind turbine environment.

The camera-system comprises a second camera, which is configured to generate images of a section of the wind turbine environment.

The first camera and the second camera are spaced vertically. The panoramic images and section-images are evaluated by the evaluation system to identify the flying animal.

As a first camera a panoramic camera is used that covers a wide or complete overview about the environment of the wind turbine.

In one embodiment a flying animal is detected using the images of this first camera. The flying animal is detected as an object in the image that is changing the position from one image to the other. Thus only one camera is needed to detect the flying object.

The second camera is needed to obtain three-dimensional information about the environment of the wind turbine, especially about the direction where the flying animal is detected.

In one embodiment only the three-dimensional information about the flying animal is needed, the second camera covers the section of the wind turbine environment where the flying animal was detected. To adjust the camera to the position of the flying animal the camera is mounted in a way that it is configured to be positioned according to the direction of the flying animal. Thus a quite “normal” camera can be used as second camera. Thus the second camera may be cheaper and less complex then the first camera. Furthermore, the amount of data provided by the second camera may be lower then the amount of data of a panoramic camera. Thus less information has to be processed in the evaluation system.

In one embodiment the second camera may be a camera with a higher resolution then a panoramic camera. Thus the picture quality is higher and the identification of the flying animal is ensured in a more easy way.

The first camera provides images of the environment of the wind turbine. The evaluation system analyzes the images and detects a flying animal. In the case a flying animal is detected, the evaluation system evaluates the direction of the flying animal seen from the camera system. The second camera is positioned to point toward the flying animal. Then the second camera provides images of the flying animal.

The two cameras are arranged in a way that they are spaced at least vertically. The mainly vertical distance serves as a basis for the two images to achieve a three-dimensional image-information. That makes it possible to calculate information about the tree-dimensional distribution of objects in the environment of the wind turbine from the two images.

The panoramic image of the first camera and the section image of the second camera are combined by the evaluation system to achieve information about the flying object like the distance, velocity or the direction of the flight.

In one embodiment the camera-system comprises a first camera, which is configured to generate panoramic images of the wind turbine environment. The camera-system comprises a second camera, which is configured to generate panoramic images of the wind turbine environment. The first camera and the second camera are spaced vertically, and the panoramic images are evaluated by the evaluation system to identify the flying animal.

The first camera is a panoramic camera that provides pictures of the environment of the wind turbine. The images are evaluated in the evaluation system.

The second camera is also a panoramic camera, which is arranged mainly in the same orientation as the first camera. The cameras are mainly oriented in a way that the images show the horizontal plane, as flying animals will approach the wind turbine from a horizontal direction.

The cameras are spaced vertically with a certain distance to provide a basis for a stereoscopic evaluation of the images of the cameras.

With a vertical distance the highest resolution of the three-dimensional information provided by the panoramic is mainly in the horizontal plane. Thus the highest resolution is in the area where flying animals approach the camera position.

The vertical distance of the cameras depends on the resolution of the images and the resolution of the three-dimensional information that is achieved in the evaluation system.

As the second camera is a panoramic camera, like the first camera, the second camera covers nearly the same area then the first camera. To achieve a stereo image the second camera can be used right away. No positioning of the second camera, according to the detection of a flying animal by the help of the first camera, is necessary. Thus no moving parts are needed. Thus no time is lost until the stereo image is achieved.

Thus the camera system provides a panoramic stereo image of the environment of the wind turbine. Thus a flying animal is detected in the evaluation system from a pair of images from the camera system.

In one embodiment the camera-system is attached to the hub of the wind turbine and thus rotates with the hub. The rotating camera-system is configured to provide panoramic images and the panoramic images are evaluated by the evaluation system to identify the flying animal.

As the camera-system is attached to the hub of the wind turbine it is located in front of the rotor blades of the wind turbine seen from the direction the wind is coming from. Thus the images of the camera-system show mainly the area in front of the wind turbine. Thus there is no influence of the rotor blades on the images in the direction where the wind is coming from. Thus a flying animal, that is approaching the wind turbine from the direction where the wind is coming from, can be detected directly and without disturbance by the rotor blades.

The camera-system is attached to the hub of the wind turbine. When the wind turbine is in operation the hub with the rotor blades rotates around the axis of rotation in respect to the nacelle and the surrounding of the wind turbine. As the camera is attached to the hub the camera rotates together with the hub.

So the plane of the image of the panoramic camera (which is normally oriented horizontally) rotates together with the hub around the axis of rotation of the hub.

The images of the camera-system are evaluated in the evaluation system. Together with the images of the camera-system the evaluation system gets the information about the orientation of the camera, so about the rotational position of the rotor.

The plane of the camera-system rotates with the hub and so scans the whole environment of the wind turbine. Together with the information about the orientation of the camera the images can be used to observe the whole area in front of the wind turbine. This can be done not only in the horizontal plane, but also out of the horizontal plane.

Thus it is possible to achieve a three dimensional information about the space around the front of the wind turbine with the camera system invented. Thus a flying animal approaching the wind turbine from the front can be detected, disregarding if it approaches the wind turbine in the horizontal plane or from another direction.

In another embodiment the first camera is attached to the hub of the wind turbine with a certain distance to the axis of rotation of the hub. When the hub rotates the camera rotates with the hub. The distance to the axis of rotation serves as half of the basis that is needed for to achieve three-dimensional information between a first position of the camera and a second position of the camera. So the camera system comprises one camera that is rotating from a first camera position into a second camera position. The images of the camera are fed into the evaluation system. The three dimensional information is calculated in the evaluation system by using several subsequent images taken by the camera from the two camera position. Thus a flying animal is detected by the use of one panoramic camera mounted to the hub of the wind turbine.

For moving objects that are distant from the camera positions, or objects that are moving slowly, two images taken at the two camera positions at different times will provide nearly the exact position of the object.

Using three images taken at different times from two camera positions reduces the error in position and distance, providing the use of a suitable correction algorithm.

In one embodiment the first and the second camera are arranged at the nacelle of the wind turbine. As the rotor of the wind turbine is attached to the nacelle, a camera-system attached to the nacelle is mainly in the middle of the height of the rotor. Thus a camera-system attached to the nacelle covers mainly the middle height of the rotor. The orientation of the camera in respect to the rotor stays the same. So the rotor blades, that appear on the images and that have to be calculated out of the image, always appear in the same area.

In one embodiment the position of the cameras is on top of the nacelle.

In another embodiment the position of the cameras is at the bottom of the nacelle.

The positions on top of the nacelle and at the bottom of the nacelle are preferred positions. This is because the camera-system is providing images of mainly the horizontal plane and the nacelle will not block the view of the camera. Thus the camera-system monitors a wide angle of the horizontal plane around the wind turbine.

In one embodiment the first and the second camera are arranged at the tower of the wind turbine.

The camera position is arranged in a certain direction of the tower to monitor a certain area in the environment of the wind turbine. Thus the cameras cover constantly a certain direction. Thus the main area, where flying animals come from, is viewed with the cameras.

In a wind park with more then one wind turbine the images achieved provides the three dimensional information of a certain area.

In one embodiment the area observed by the cameras is the area pointing away from the other wind turbines. Thus the boundaries of a wind park are observed by the cameras. Thus flying animals approaching or entering the wind park are detected.

In one embodiment the warning system is configured to scare off the flying animal by the warning signal.

A warning signal to scare away a flying animal is a loud noise, like a bang, or the scream of a bird of prey, an ultrasonic sound, an infrasound or a visible signal like a flashlight for example. The warning signal is capable of influencing to flying animal to change the direction of the flight. Thus a collision with a flying animal is avoided and the energy production of the wind turbine continues unchanged.

In one embodiment the warning system is configured to generate a control-signal, which is used to control the wind turbine in a way that animal-strikes are reduced or even avoided.

In one embodiment a control-signal to control the wind turbine is a signal to set the pitch angle of the rotor blade

In another embodiment the yaw angle of the nacelle is controlled by the control-signal.

The wind turbine is stopped or the speed of the rotor of the wind turbine is reduced. Thus a collision of the flying animal with fast moving rotor blade of a wind turbine is avoided.

In one embodiment the warning system is configured to transfer the control-signal to another wind turbine, to a remote control or to an operator.

In a wind park a first turbine detects a flying animal. This first turbine transfers the control-signal to a second turbine in the wind park. This second wind turbine is not equipped with a camera-system or has not detected the flying animal yet. Thus the second turbine is controlled according to the control-signal of the first turbine before the second turbine detects the flying animal. Thus time is saved to control the second turbine in advance before the flying animal arrives at the second turbine. Also equipment is saved as not every wind turbine in a wind park needs to be equipped with a camera-system and an evaluation system.

In one embodiment a species of the flying animal is identified based on the evaluation of the images. Thus the species of the flying animal is known. Thus the warning signal can be generated selectively according to the species of the flying animal. Thus the risk of a collision of this species of flying animal with the wind turbine is minimized.

In one embodiment the species of the flying animal is detected and the result is saved. Thus the different species detected in the environment of the wind turbine are known and can be counted. Thus the knowledge about the animals, their behavior and their reaction to the warning signal is increased.

In one embodiment at least the distance and the trajectory of the flying animal are calculated in reference to the wind turbine.

Thus the distance and the trajectory of a flying animal are known the future flight path can be estimated. Thus the time of arrival in the area of the rotor of the wind turbine is known, and the possibility and risk of a collision with the wind turbine can be evaluated.

In one embodiment a risk of a collision of the flying animal with the wind turbine is calculated, and the warning signal is generated, when the risk of a collision is above a certain predetermined value.

Thus the warning signal is not generated, when the risk of a collision is low. Thus the flying animal is not disturbed in its natural behavior and/or the energy production of the wind turbine is not lowered, if there is no or just a low risk of a collision.

In one embodiment the size of the flying animal is evaluated, and the warning signal is generated when the size of the flying animal is above a certain predetermined size.

Thus a warning signal is not generated when a small flying animal like an insect is detected by the evaluation system. Most of the insects are not endangered so that it is not useful to influence the energy production of the wind turbine to avoid a collision of the rotor blades with an insect. An insect can also not be scared away by a warning signal.

In one embodiment data are derived from the animal-identification and/or data are derived from the trajectory or the distance of the flying animal in reference to the wind turbine, and the derived data are used to improve the evaluation.

The data of the detection and identification is saved. In addition the data of the flight-path of the animal is saved. So also the change in the flight path of the flying animal in reaction to the warning signal is saved. Thus the reaction of the animal to the warning signal can be analyzed.

The knowledge about reaction of the animal is used to improve the evaluation system. Thus the data about the species present in the environment of the wind turbine is used to refine the reaction of the wind turbine. Thus the generation of the warning signal of the wind turbine is adjusted to the local species of flying animals and behavior of the local flying animals.

In one embodiment a learning algorithm is implemented in the evaluation system to improve the process in the evaluation system.

The data is used to adjust the settings in the evaluation system. By use of a learning algorithm the evaluation system is improving its reaction to the flying animal. Thus the efficiency of the evaluation system and the warning system is increased. Thus no expert in the field of the behavior of flying animals is needed to analyze the data stored in the evaluation system and to improve the generation of the warning signal.

### BRIEF DESCRIPTION OF THE DRAWINGS

An aspect of the invention is shown in more detail by help of a figure.

The FIGURE shows one embodiment and does not limit the scope of the invention.

### DETAILED DESCRIPTION OF INVENTION

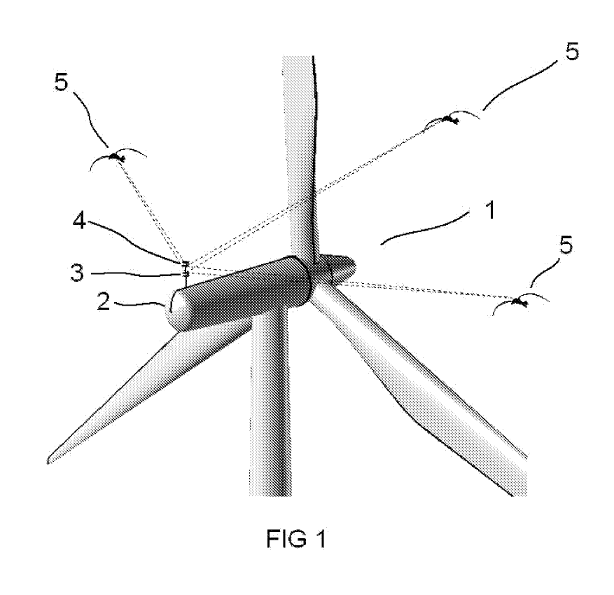

FIG. 1 shows a wind turbine 1 with an arrangement invented. The wind turbine 1 comprises a tower and a nacelle 2 on top of the tower. Attached to the nacelle 2 is a hub with the rotor blades of the wind turbine. The cameras 3, 4 are attached to the nacelle of the wind turbine. The cameras 3, 4 are shown on top of the nacelle at the rear end, which is the end of the nacelle pointing away from the rotor of the wind turbine 1. The two cameras 3, 4 are spaced vertically. The cameras 3 and 4 are panoramic cameras that take 360° images in mainly the horizontal direction.

Three flying animals 5 are shown on the figure, every flying animal 5 in a different position in the area of the wind turbine. Every flying animal 5 is imaged with both cameras 3 and 4. The position of one flying animal 5 on the images of the two cameras 3 and 4 is different. From this difference the position of the flying animal 5 is calculated in a three dimensional space around the wind turbine 1.

So the presence of a flying animal 5 and its position in space is detected with one set of images achieved by the two panoramic cameras 3 and 4. Also the species of the flying animal 5 can be recognized by the evaluation system using a picture recognition system known in the state of the art.

When a flying animal like a flying animal 5 is detected the trajectory of the flying animal 5 can be calculated with the information achieved in a second set of images of the two panoramic cameras 3, 4.

With two sets of images the flight path of the flying animal 5 for the near future is calculated. Also the risk of a collision of the rotor blades of the wind turbine 1 with the flying animal 5 is calculated.

When the risk of a collision exceeds a certain predetermined value, a warning signal is generated. The warning signal can be produced in a way that the flying animal 5 is scared away from the turbine, so that the collision of the flying animal 5 with the wind turbine blade can be avoided.

1. An arrangement to prevent a collision of a flying animal with a wind turbine, comprising:
a camera-system, which is arranged at the wind turbine, generates a plurality of images of the environment of the wind turbine, the plurality of images includes a panoramic image of the wind turbine environment;
an evaluation system, which is coupled with the camera-system, evaluates the images to detect a flying animal within the environment of the wind turbine; and
a warning system, which is coupled with the evaluation system, generates a warning signal when the flying animal is detected by the evaluation system.

2. The arrangement according to claim 1,
wherein the camera-system comprises:
a first camera configured to generate the panoramic images of the wind turbine environment, and
a second camera configured to generate images of a section of the wind turbine environment,
wherein the first camera and the second camera are spaced vertically, and
wherein the panoramic images and section-images are evaluated by the evaluation system to identify the flying animal.

3. The arrangement according to claim 1,
wherein the camera-system comprises
a first camera configured to generate panoramic images of the wind turbine environment, and
a second camera configured to generate panoramic images of the wind turbine environment,
wherein the first camera and the second camera are spaced vertically, and
wherein only the panoramic images are evaluated by the evaluation system to identify the flying animal.

4. The arrangement according to claim 1,
wherein the camera-system is attached to the hub of the wind turbine and thus rotates with the hub,
wherein the rotating camera-system is configured to generate panoramic images, and
wherein the panoramic images are evaluated by the evaluation system to identify the flying animal.

5. The arrangement according to claim 2, wherein the first and the second cameras are arranged at a nacelle or a tower of the wind turbine.

6. The arrangement according to claim 3, wherein the first and the second cameras are arranged at a nacelle or a tower of the wind turbine.

7. The arrangement according to claim 1, wherein the warning system is configured to scare off the flying animal by the warning signal.

8. The arrangement according to claim 1, wherein the warning system is configured to generate a control-signal, which is used to control the wind turbine in a way that animal-strikes are reduced or prevented.

9. The arrangement according to claim 1, wherein the warning system is configured to transfer the control-signal to another wind turbine, to a remote control or to an operator.

10. A method to prevent a collision of a flying animal with a wind turbine, comprising:
generating images of the environment of the wind turbine;
evaluating the images to detect the flying animal within the environment of the wind turbine; and
generating a warning signal is generated if the flying animal is detected,
wherein at least panoramic images of the wind turbine environment are generated for the evaluation.

11. The method according to claim 10, further comprising identifying a species of the flying animal based on the evaluation.

12. The method according to claim 10, further comprising calculating a distance and a trajectory of the flying animal in reference to the wind turbine.

13. The method according to claim 11, further comprising calculating a distance and a trajectory of the flying animal in reference to the wind turbine.

14. The method according to claim 10, further comprising:
calculating a risk of a collision of the flying animal with the wind turbine; and
generating the warning signal when the risk of a collision is above a predetermined value.

15. The method according to claim 12, further comprising:
calculating a risk of a collision of the flying animal with the wind turbine; and
generating the warning signal when the risk of a collision is above a predetermined value.

16. The method according to claim 13, further comprising:
evaluating the size of the flying animal; and
generating the warning signal is generated when the size of the flying animal is above a predetermined size.

17. The method according to claim 14, further comprising:
evaluating the size of the flying animal; and
generating the warning signal is generated when the size of the flying animal is above a predetermined size.

18. The method according to claim 15, further comprising:
evaluating the size of the flying animal; and
generating the warning signal is generated when the size of the flying animal is above a predetermined size.

19. The method according to claim 10,
wherein data is derived from the animal-identification and/or
wherein data is derived from the trajectory or the distance of the flying animal in reference to the wind turbine, and
wherein the derived data is used to improve the evaluation.

20. The method according to claim 11,
wherein data is derived from the animal-identification and/or
wherein data is derived from the trajectory or the distance of the flying animal in reference to the wind turbine, and
wherein the derived data is used to improve the evaluation.
